(19) United States
(12) Patent Application Publication
(10) Pub. No.: US 2026/0177184 A1
(43) Pub. Date: Jun. 25, 2026

(54) METHOD FOR OPERATING A WORKING APPARATUS IN A PIPELINE, AND WORKING APPARATUS

(71) Applicant: Rosen IP AG, Stans (CH)

(72) Inventors: Ingo Nee, Dörpen (DE); Matthias Grote, Lingen (DE)

(21) Appl. No.: 19/126,687

(22) PCT Filed: Nov. 1, 2023
(86) PCT No.: PCT/EP2023/080475

§ 371 Date: May 2, 2025

(30) Foreign Application Priority Data
Nov. 2, 2022 (BE) BE2022/5889

(51) Int. Cl. F16L 55/46; B08B 9/055; F16L 55/48; G06F 9/455

(52) U.S. Cl. CPC F16L 55/46; B08B 9/055; B08B 9/0551; B08B 9/0557; F16L 55/48; G06F 9/455

(57) ABSTRACT

A method is provided for operating a working apparatus in a pipeline. The working apparatus is moved in the pipeline passively by the medium in a flow direction of the pipeline in a first operating state. The working apparatus reaches or approaches a destination in the pipeline in a second operating state. The working apparatus performs at least one working-apparatus-specific procedure in the pipeline at the destination in at least one third operating state. The working apparatus thereafter moves away from the destination after a change from the third operating state into the first or second operating state. The untethered working apparatus records items of surroundings information by at least one surroundings sensor in the first and/or second operating state, which are evaluated in a computing unit of the working apparatus. The working apparatus automatically changes the operating state on the basis of the items of surroundings information.

### CROSS REFERENCE

This application claims priority to PCT Application No. PCT/EP2023/080475, filed Nov. 1, 2023, which itself claims priority to Belgian Patent Application No. BE 2022/5889, filed Nov. 2, 2022, the entireties of both of which are hereby incorporated by reference.

### FIELD OF THE INVENTION

The present invention relates to a method for operating an implement in a pipeline provided with a medium flowing in the axial direction, wherein the implement in the pipeline is moved passively by the medium in the direction of flow of the pipeline in a first operating state, then the implement reaches or approaches a target in the pipeline in a second operating state and carries out at least one implement-specific procedure at the target in the pipeline in at least a third operating state. The implement then moves away from the target, especially after changing from the third to the first or second operating state.

Furthermore, the invention relates to an implement comprising at least one propulsion means for a first operating state in the form of a medium-driven, passive movement in the pipeline and comprising at least one environmental sensor for picking up environmental information. In particular, the implement is a pipeline pig which is cable-unconnected, i.e. without a cable connection, for example for energy transmission and communication purposes.

### BACKGROUND OF THE INVENTION

A method is known from EP 3 099 967 B1. A passively driven pipeline pig is initially medium-driven in a first operating state in which it approaches a target. At a certain point in time, a braking process is initiated, for example by expanding sealing sleeves that are against the pipeline wall. This reduces the speed at which the pig moves in the pipeline. The braking process characterizes a second operating state which is distinguishable from the first operating state in terms of speed. At the target, the pig is firmly anchored in the line or pipeline. In the third operating state, the speed relative to the pipeline is thus equal to zero, and the pig can carry out an implement-specific procedure, for example, in the prior art, evacuation or release of a pipeline section intended for repair. After repairing the pipeline, the pig can then move away from the target. A generic implement, in particular an implement, has at least one propulsion means for a first operating state in the form of a medium-driven passive movement in the pipeline, for example caps or discs. In addition, the pipeline pig is provided with an environmental sensor for picking up environmental information. In the prior art, this is

A method is known from EP 3 099 967 B1. However, the field of application of the implement according to the prior art and the applicability of the generic method are limited in the prior art, since the implement must be controlled remotely.

### BRIEF SUMMARY OF THE INVENTION

The object of the present invention is to design a method for operating an implement and an implement, in particular a pig, for a wider range of applications.

A method according to the invention is distinguished by the fact that the cable-unconnected implement picks up environmental information during the first and/or second operating state using at least one environmental sensor, said information is evaluated in a computer unit of the implement, and the implement changes the operating state on the basis of the environmental information. The implement is thus autonomous and is able to independently change the operating state on the basis of the evaluated information.

Environmental information is information that makes it possible to represent the environment of the implement. The environment comprises in particular the medium, the pipeline with its possible installations and/or any electrical and/or magnetic fields present in the environment of the pipeline, e.g. the earth's magnetic field. In particular, environmental information does not include any control and communication signals which come from any external and remote control unit of the implement and are transmitted to the latter with the aim of triggering an action or reaction of the implement. In particular, environmental information is information that results from technical features of the pipeline, including any installations. The technical features include, for example, welds, diameters and/or defects. The implement works independently insofar as it decides independently whether or not an operating state is changed on the basis of the environmental information in the computer unit.

An implement according to the invention, which is in the form of a cable-unconnected implement, has at least one environmental sensor for picking up environmental information and at least one drive means for a second operating state in the form of an active movement of the implement, in particular in the form of a pig, in the pipeline. Furthermore, a computer unit of the implement, in which environmental information can be stored, is configured such that the implement carries out the method according to the invention. In particular, the computer unit and an associated processor or a computer program running in this processor are configured such that the cable-unconnected implement picks up environmental information during the first and/or second operating state using at least one environmental sensor, the environmental information is evaluated in a computer unit of the implement, and the implement changes the operating state on the basis of the environmental information.

This means that the implement is now able to orient itself in the pipeline, arrive at a predefined target or a target defined during the movement through the pipeline and perform a desired operation there. In particular, this or another operation can be performed repeatedly at different destinations along the entire pipeline. In particular, an implement according to the invention is equipped with a preferably adjustable bypass so that it does not block the line flow when firmly positioned at a location.

The computer unit of the implement comprises at least one CPU or other processor unit (GPU, TPU, FPGA), at least one main memory, in particular in the form of a random access memory or another dynamic memory, and at least one permanent memory, for example in the form of a read-only memory or another permanent main memory, which may contain one or more databases. In addition, individual functional parts of the implement, such as sensors, an energy store, drive means or the like, can be connected via a bus system, for example. The energy store, with any battery management system, can also be considered to be part of the computer unit. Due to its software, the implement is configured in such a way that it implements the method according to the invention. This software can be structured in particular in a modular manner, with the result that only those modules which are required in the respective operating state are or have been loaded into the main memory for the implementation of a lean and efficient program.

The environmental information is evaluated in the corresponding computer unit in which a corresponding computer program or corresponding software is running. By means of this computer program running on the computer unit, the operating state is accordingly changed independently on the basis of the environmental information, without the implement communicating with a remote control unit for this decision-making.

The implement has at least one propulsion means for a passive and medium-driven operating state and at least one drive means for a second operating state in the form of an active movement. This may be a drive means which drives against or with the flow of the medium, but, in particular, a relative speed with respect to the medium is achieved by actuating the drive means. It may be a drive means through which the implement actively supports itself on the wall of the pipeline and moves along with respect to the latter. For example, these may be drive rollers, magnetic wheels and/or chain or caterpillar drives. Alternatively or additionally, it may be a drive means which causes a drive by acting on the medium, for example one or more nozzles or a propeller/impeller.

To reduce the influence of the passive propulsion means, these can be transferred, in accordance with a further advantageous embodiment, from their operating position, in which they fill the inner pipeline cross section for optimum passive propulsion, to a rest position located more closely to a central longitudinal axis of the implement, at least partially by means of one or more propulsion means actuating means. This rest position is in particular one in which the implement is no longer sufficiently driven by the medium alone and in particular is no longer passively driven, since the thrust by the medium can no longer overcome or can only slightly overcome the friction between the implement lying on the wall of the pipeline and the wall. The implement can at least brake or even stop by transferring to such a rest position.

A target is a position in the longitudinal direction of the pipeline, an area along a specific pipeline section, or a combination of the two. To reach a target, it can be defined and stored in a map of the pipeline that is stored in the computer unit. It can also be a target or an area of a pipeline that is identified as the implement moves through the pipeline and is defined as important for further investigation.

Due to the invention, an implement in the pipeline can first move passively over long distances with the flow and using only low energy resources, can then change from the operating state that is passive with respect to the movement to a further operating state characterized by an active movement in order to approach a target and can thus move in a controlled manner towards the target in order to then carry out, for example, a certain inspection or a repair process at the destination. This applies both to predefined targets and to those targets which are defined during a run, for example one or more areas with defects that are initially crossed by the implement, wherein environmental information regarding the defects is picked up and is then evaluated. If the areas with defects are identified as sufficiently interesting targets in the computer unit, the implement can then actively return to these areas and can perform an implement-specific operation there, for example more detailed, longer-lasting measurements.

The implement can move both in the direction of the flow and against the flow in the second and possibly third operating state. Accordingly, any drive means, in particular, are also designed to drive the implement against the flow.

The drive means for actively moving the implement can affect the position of the implement in the axial direction along the pipeline, especially in the forward and reverse directions. Preferably, they may also affect the location or alignment of the implement around its longitudinal axis in the pipeline, for example in order to rotate a pipeline pig, which has a certain sensor at a certain circumferential position, into the desired position around the central longitudinal axis of the pipeline pig.

The position in the longitudinal direction of the pipeline may be a length in metres, for example with reference to an origin; it may also be a position which defines a pipeline segment, for example, by a number of circumferential welds starting from an origin.

In a development according to the invention or in a further invention, the position can be defined by a combination of flow velocity and time. Accordingly, it is an option for a method according to the invention that the progress of the implement in the pipeline is defined by the elapse of time and the implement changes the operating state on the basis of the elapsed time. In an invention, such a variant can also change the operating state without, or additionally due to, the evaluation of environmental information, wherein the implement is also again equipped with active and passive drive or propulsion means and with a computer unit that ensures that the operating state is changed. In such an invention, the implement or the method may additionally have the features described above and below for control.

Referring again to the invention defined in the independent claims, the implement according to the invention can pick up, as environmental information, the line moved along on the inside of the pipeline, in particular using an odometer. Alternatively or additionally, there may be an environmental sensor in the form of a Hall sensor which receives magnetic signals generated by means of one or more magnetic markers on the pipeline. Alternatively or additionally, the environmental sensor may be a micromagnetic sensor that picks up the magnetic field outside the pipeline or the magnetic field that can be detected thereby in the pipeline. Whereas the environmental sensor can thus perceive in the widest case everything that is present outside the implement and around it, for a development of the invention, the at least one environmental sensor is limited to the medium located in the pipeline and/or to the features of the pipeline that can be perceived from the inside. For example, these are one or more geometry sensors, sensors for NDT methods (EC, MFL, ultrasonic sensors), or optical sensors that allow the implement to perceive the internal pipeline, its condition, and thus its environment.

Due to the change according to the invention between the various operating modes and the option for the implement to change between the various operating states due to its propulsion and drive means, the implement can proceed situationally, and a wide range of coverage and tasks is covered. Whereas inspection tasks that require little energy input are performed in the first operating state with passive operation, an accurate inspection with correspondingly high energy input can be carried out while approaching a target and especially during positioning at a target. For this purpose, it is advantageous if the implement according to a further embodiment of the invention has means for generating energy from the medium, for example a generator driven by the medium.

Advantageously, the implement has positioning and/or fixing means for positioning the implement in a third operating state and for a standstill in the pipeline. These can be fixing means which are in the form of clamping means and are used to clamp the implement in the pipeline. Depending on the design of the invention, the drive means or a plurality of drive means can also be used for this purpose and can be used to effect clamping in the pipeline.

In addition to the active drive means, an implement according to the invention may also have one or more fixing means which are simultaneously in the form of propulsion means and are used to fix the implement in the pipeline. For example, these can be cups or discs whose outer diameter can be enlarged and which can become stuck in the pipeline as a result of enlargement of the outer diameter. In addition to conventional cups and guide discs, a bypass can also be part of the propulsion elements provided for passive operation, which bypass is opened or closed on the basis of the findings stored in the computer unit.

According to the invention, at least one feature of the pipeline is identified in the computer unit by evaluating the environmental information. Preferably, this is used in the computer unit to determine the position of the implement. One such feature is, for example, a circumferential or transverse weld which is used to connect individual pipeline segments to one another. Identifying the welds in the computer unit on the basis of, for example, environmental information from a geometry or eddy-current sensor and a summation of the number makes it possible to determine the position of the implement in a pipe segment-specific manner in the computer unit.

If the length of the segments is known, the position can also be determined in units of length. For this purpose, the lengths of the pipe segments are known in the computer unit. Depending on the distance from a target, a change to an active movement can be started in the computer unit when a known quantity of transverse welds is reached, which is generally associated with a reduction in speed. Preferably, the propulsion forces are reduced for this, due to the pressure exerted on the implement by the medium, by reducing the diameter spanned by the cups or discs and/or opening a bypass. Alternatively or additionally, it is also possible to use braking means. Braking means can be means worked separately from the cups or discs or can also be formed by these, at least if this function does not oppose a diameter reduction.

In addition to the general differentiation between passive and active movement, the first or the second operating state can also be characterized by a sequence of different actions of the implement. For example, a speed can first be reduced, by opening a bypass, to a desired speed, from which caterpillar tracks or other actively actuatable drive means, which are supported with respect to the pipeline wall, become active.

In order to improve the orientation of the implement, a feature of the pipeline, with its position in the pipeline, can be stored in the computer unit, in particular wherein a position of the implement in the pipeline is determined on the basis of the environmental information in the computer unit, preferably at least during the first and the second operating state and in particular continuously. In particular, the implement changes the operating state on the basis of the position.

In order to change from a passively operated mode, which can also be referred to as the pigging mode, to a mode in which the implement moves independently in the pipeline, which can also be referred to as the crawler mode, a maximum speed should not be exceeded. If the implement is moving too fast, it must first be braked to a certain maximum speed, preferably wherein the computer unit is designed to initiate a braking process in good time, depending on the distance to the target and the speed. The speed can be recorded using an odometer and corrected, if necessary, by a based on the time and distance covered on the basis of additional environmental information. Preferably, the operating state is changed on the basis of the distance of the implement from the target.

Appropriate instructions for determining the speed and/or reducing the speed can be stored in a set of rules of the computer unit. Such a set of rules can also be referred to as a digital map, in which the pipeline is represented and in which specific instructions for action for specific positions are stored. The implement is then able to use the environmental information to identify the position of the implement, in particular in the form of a pig, to compare it with the digital map and to implement the instructions stored in the corresponding position field or target field. For example, when a certain segment of a pipeline is reached, characterized by a number of detected welds, a braking process can be presented in order to arrive, from a further segment in an active movement, at a weld which terminates this segment and is then examined at a standstill in the third operating state.

Instead of opening a bypass in order to reduce the speed, or in addition to opening the bypass, the implement in the form of a pig can also be braked by friction on the inner wall of the pipe, for example due to extendable or inflatable cups or discs. As soon as the maximum speed is undershot, caterpillar tracks can also extend, for example, and the implement can continue to move in crawler mode. If the target area or target is then reached, any fixing means are extended and the implement is fixed in stationary mode. In this case, the third operating state is thus one in which the pig does not continue to move relative to the pipeline. Alternatively, the third operating state may also be characterized by very slow movement of the implement along the pipeline, in particular at a speed of less than 0.5 m/min, for measuring purposes.

After the measurement process, the release of the fixing means and any active drive means and partial or complete closure of a bypass can transfer the device to the pigging mode again in order to continue to the next position.

Continuously determining the position of the implement means that the latter can also more easily check and respond to its own state. For example, it is possible to decide, by monitoring the available energy and using the knowledge of energy required for certain operating states, measurement or inspection processes that is stored in the computer unit, that the implement is transferred to an energy collection mode, for example, when the available energy is no longer sufficient to actively move to the target. For this purpose, the implement may have a generator unit which can be used to absorb energy from the medium due to a speed difference, for example via a propeller driven by the medium.

The third operating state comprises in particular a decelerated measurement run and/or sticking in the pipeline. Preferably, the third operating state comprises arresting and sticking in the pipeline, while the implement is moving actively in the second operating state, i.e. with its own drive force in the direction of the longitudinal direction of the pipeline. In general, the operating states differ in terms of different motion states and any associated measurement and work processes. For example, during a passive movement through the pipeline, inspection data can be acquired in a conventional manner, which inspection data only roughly represent the pipeline and are suitable for identifying any features or characteristics of the pipeline.

In particular, the second operating state is characterized in that the implement moves actively in the pipeline via at least one drive means. In particular, this may be a movement in and/or against the direction of any flow present during operation of the pipeline. The second operating state comprises in particular movement speeds of less than 1 m/s.

Preferably, environmental information is also picked up during the third operating state, which environmental information is on the one hand data useful for recognizing the environment and the associated position of the pig or implement, as well as, alternatively or additionally, inspection data.

The position of the implement is recognized in an improved manner when environmental information obtained from different environmental sensors is used in the computer unit to determine features of the pipeline and/or to determine the position of the implement in the pipeline. For this purpose, the implement has a plurality of environmental sensors, in particular different environmental sensors.

The environmental information from a plurality of identical and/or different environmental sensors can be linked together via a data fusion in order to gain a higher information quality. This can be the fusion of data from a plurality of environmental sensors of the same type and/or different sensor types. On the one hand, this results in failure safety if one of the environmental sensors fails. Furthermore, an increased level of trust can be created by recognizing features in a plurality of sensor sources independently of each other in such a way that the probability of the feature being present is higher. For example, the determination of the position on the basis of an odometer and an IMU (Inertial Measurement Unit) can also lead to a redundancy of the speed measurement, which increases the certainty in the determination of the location.

Preferably, the position of the implement is determined in the computer unit on the basis of the environmental information and by means of a digital map of the pipeline that is stored in the computer unit. In a simple case, a digital map is a table containing waypoints or distance points and associated features. It can also be a “digital twin” of the pipeline, i.e. a representation of the pipeline, which represents the pipeline in cylinder or 3D coordinates, for example, wherein individual positions of the pipeline can be assigned certain features. The digital map can be represented by one or more data sets that can be linked to each other or can be related by a program of the computer unit.

Preferably, reference points are represented in the digital map, e.g. in the form of welds, markers, installations or bends, and the environmental information is evaluated for the purpose of identifying such reference points. The features of the pipeline that are recognized on the basis of the environmental information can be compared with these reference points, and the position of the pig or implement can be determined more precisely or an implement-specific action can be triggered, such as a transition to another operating state, a measurement, a treatment of the pipeline and/or a repair. The evaluation is carried out in the computer unit of the implement.

In general, an implement-specific procedure is an action of the implement in which the capabilities of the implement take effect. In particular, it is an acquisition of data at a target in the pipeline, including, for example, a measurement, a treatment and/or another action with regard to the pipeline. It can also be a transition from one operating state to another or the adoption of an operating state.

Preferably, at least some of the environmental information is classified in the computer unit, and the data derived therefrom are compared with the data of predefined patterns, in particular for feature recognition. On the basis of such a comparison, the operating state can be changed and/or at least one desired work procedure can be carried out. For example, the implement can carry out a screening measurement method in the target area with a sensor, with the aim of identifying and locating defined points in the form of defect patterns, for example. Such a measurement method can initially be of a coarse resolution and can have a long range; for example, it can be a long-range UT method here. The signals picked up are then recorded and automatically analysed by the implement in the computer unit. In this case, the classified measurement signals can be compared with predefined classes (patterns). If a specific pattern or specific class is now recognized, the implement can carry out an instruction prescribed for such a pattern and, for example, can carry out a detailed inspection of a possible defect area using PAUT (Phased Array Ultrasonic Testing). The pattern recognition method, for example based on ML models, can lead to the assignment of a confidence level that determines whether or not a particular work procedure is performed. For example, if the confidence level is too low, it is not possible to carry out a fine-resolution inspection.

A coarse-resolution measurement method can also already be performed as screening during the first operating state. If a defect area not represented in the digital map is already identified, for example, during such screening and associated pattern recognition, a rule that is stored in the computer unit can be that this area is approached and examined separately again in the second or third operating state. Accordingly, the implement in the pipeline will move to that area again, in which case a return against a media flow present in the pipeline may also be included.

Preferably, in particular for a movement in the direction against the flow, one or more possibly existing bypasses through or along the propulsion means provided for passive propulsion can be opened in order to minimize the flow resistance. Alternatively or additionally, the propulsion means themselves can be opened, retracted or otherwise minimized in terms of their area susceptible to the flow.

Advantageously, location-dependent instructions in particular are stored in the computer unit in the digital map and/or at least in one further data set of the computer unit and are carried out by the implement upon reaching the target or upon recognizing a feature. The implement can autonomously decide to change to one of the different operating modes or to perform various actions on the basis of its environmental sensors. The further data set of the computer unit can be part of a database that is stored on the computer unit of the implement. It can also be a data set of a program module that is loaded or started by the program running on the computer unit, or is part thereof.

Generally, an in particular coarse-resolution inspection is advantageously possible during the first passive mode or operating state, and screening or a more detailed examination can also be carried out during a second operating state with active movement. During a third operating state, during a yet further decelerated run or a standstill of the implement in the pipeline, a detailed inspection or tool application for treating the pipeline can be carried out. In addition, during the second operating state, just like in the third operating state, any points to be examined or generally the inside of the pipe wall can be cleaned. It is also possible, depending on the design of the invention, to carry out cleaning and/or repair as well as a detailed inspection in the third operating state.

The implement-specific behaviours and/or procedures used during one of the three operating states may also change depending on the pipeline being examined and its properties. For this purpose, the computer unit can be equipped with appropriate rules and instructions in advance. For example, cleaning can be carried out in the event of visible soiling of the pipelines, for which a milling tool can be used for example, while a detailed inspection can be carried out at another position during the third operating state.

Advantageously, the computer unit is configured such that the in particular location-dependent instructions are carried out on the basis of rule-based decisions represented in the computer unit. A corresponding set of rules can be designed specifically for the implement and can thus take into account the capabilities of the implement for inspection, cleaning and/or repair. For example, depending on recognized defects or defect patterns that can be found again in one or more data sets containing surroundings or environmental information, the defect or defect pattern can be checked or treated.

Advantageously, therefore, one or more work procedures, generally from a group of different work procedures which can be implemented by the implement, can be carried out simultaneously or successively on the basis of the evaluation of the environmental information, in particular wherein the implement carries out an inspection and/or pipeline repair in the third operating state.

For the purpose of carrying out inspections or repairs, the implement may have at least one tool that can be activated during at least one operating state and is in particular a sensor or a tool for mechanically treating the pipeline, for example a cleaning tool. It can also be a coating tool for coating the pipeline or a tool removing material from a pipeline wall.

In particular, the implement has at least one manipulator arm which is equipped in particular with a tool holder. Depending on the procedure specified, the implement can then automatically change the associated tools. These are contained in particular in a magazine for storing tools. This may be arranged in a section of the implement. Alternatively or additionally, one or more tools can be arranged in a tool holder on the outside of the pig body. The manipulator arm can be designed in a similar manner to a robot arm and can work in a multi-axis manner and access the at least one tool arranged in the magazine or the holder. A tool holder can be in the form of a standardized interface which can operate different tools. Such an interface is used on the one hand to fix the tools, for example by means of a screw connection or clamping, to supply energy and to transmit data. The tools may be attached and fixed at defined locations on or in the implement, specifically in such a way that the manipulator arm can easily grip them. If the manipulator arm and tool are successfully connected, the tool can be released from the original storage location, in particular from the magazine, so that the manipulator arm can perform the desired operation with the tool.

Reference points obtained from the environmental information may be used in particular to calibrate the location and/or to accurately determine the position of the implement. This allows the position of the implement to be determined more accurately by the latter, with the result that on the one hand the inclusion of still unknown features of the pipeline in a digital map is improved and on the other hand the actions of the implement that are carried out on the basis of the position can be carried out in a more targeted manner. In particular, the energy input for the available procedures has been improved.

Advantageously, the digital map is supplemented with pipeline condition information obtained from the environmental information and/or further sensor information, e.g. in the form of bumps, hot taps, corrosion, defects and welds. Such a digital map can then be downloaded from the implement after the run through the pipeline has been completed and can be used for further implements or for a further run of the same implement.

Possible services of the implement may be, in particular, an inspection during the first motion state and screening for initially identifying abnormalities in the second operating state, which are then inspected in the third operating state as part of a deep inspection. Furthermore, the implement can be used for cleaning and disposal of e.g. wax deposits, for collecting and removing unwanted parts (e.g. sensors, magnets), for surface treatment, e.g. hardening, sandblasting, for coating, spraying and for additive manufacturing methods, for filling (up) defects and/or for maintenance work, e.g. adjusting, bending and aligning parts in the pipeline, e.g. a slide, as well as for conventional manufacturing in the form of milling, drilling, gluing, welding, grinding.

An energy generation apparatus which is present according to one exemplary embodiment of the invention and generates energy stores it in particular in an energy store of the implement. It is preferably electrical energy that is stored in a rechargeable battery.

Reference is now made more particularly to the drawings, which illustrate the best presently known mode of carrying out the invention and wherein similar reference char-acters indicate the same parts throughout the views.

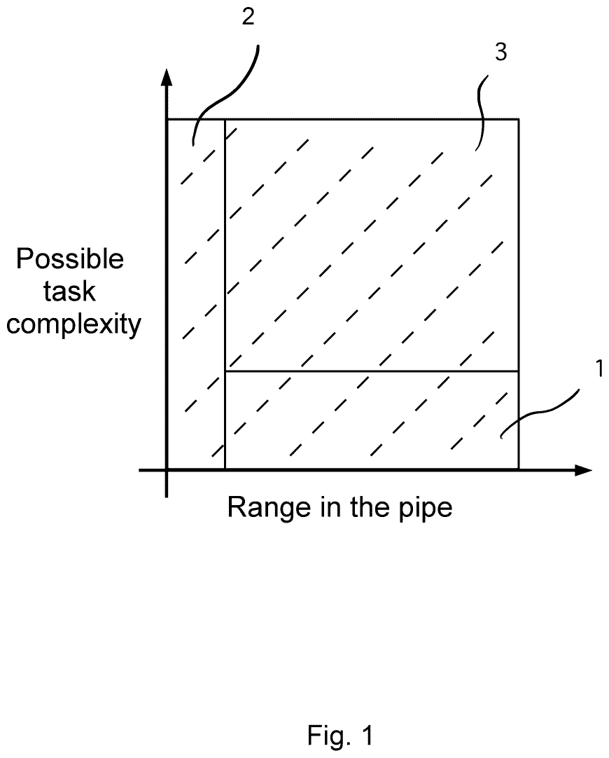

FIG. 1 shows a schematic illustration of the field of application of the implement according to an example embodiment of the invention.

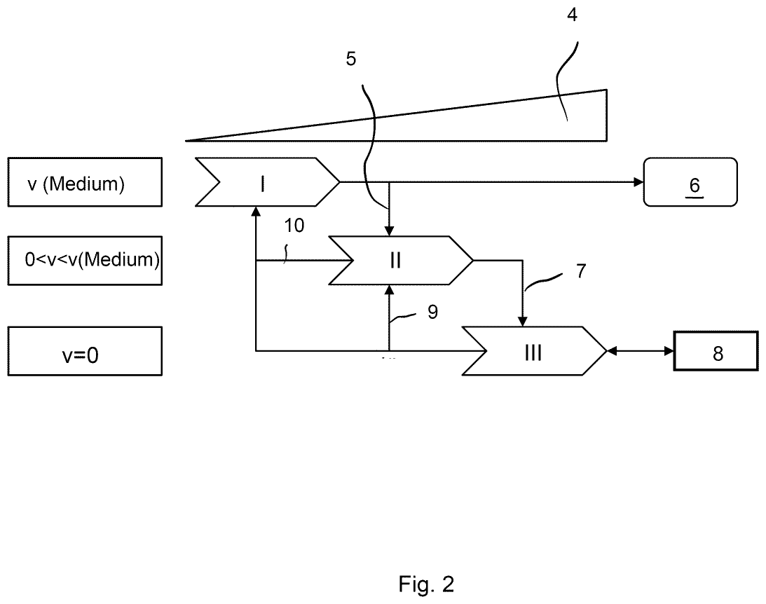

FIG. 2 shows a further schematic illustration of an example embodiment of the invention in a flowchart.

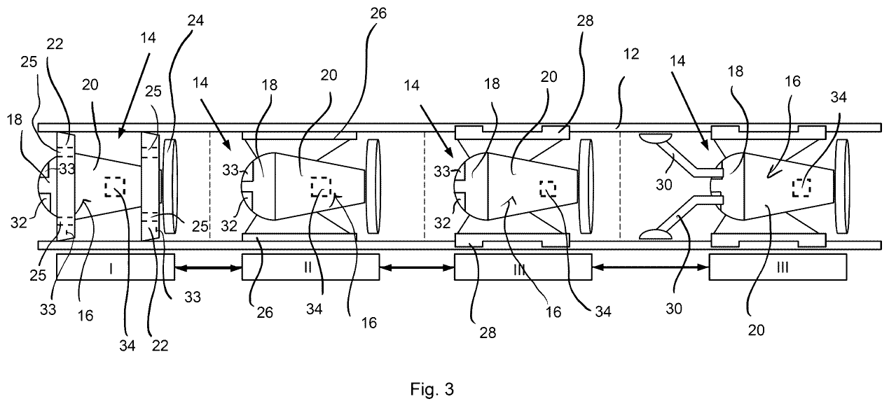

FIG. 3 shows the various operating states of an implement according to an example embodiment of the invention.

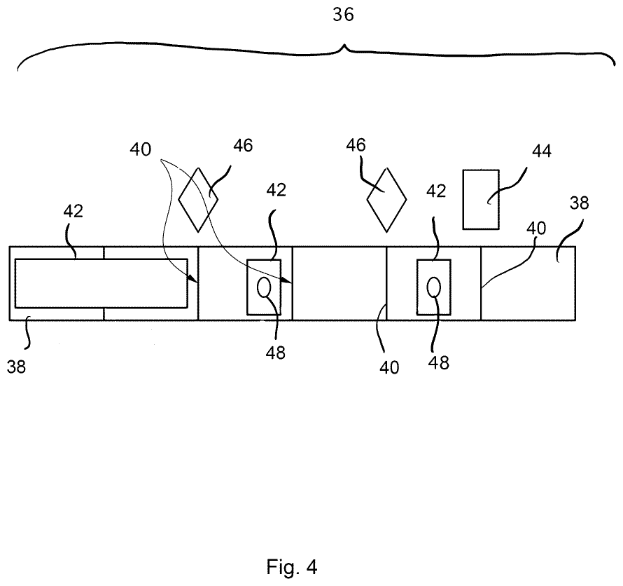

FIG. 4 shows a simplified illustration of a digital map.

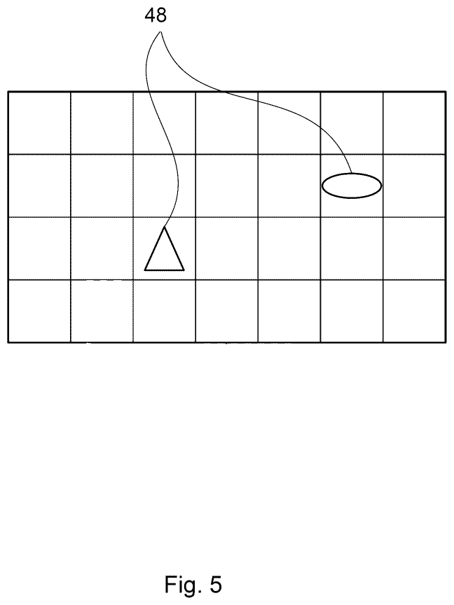

FIG. 5 shows a further example of a digital map stored in a computer unit.

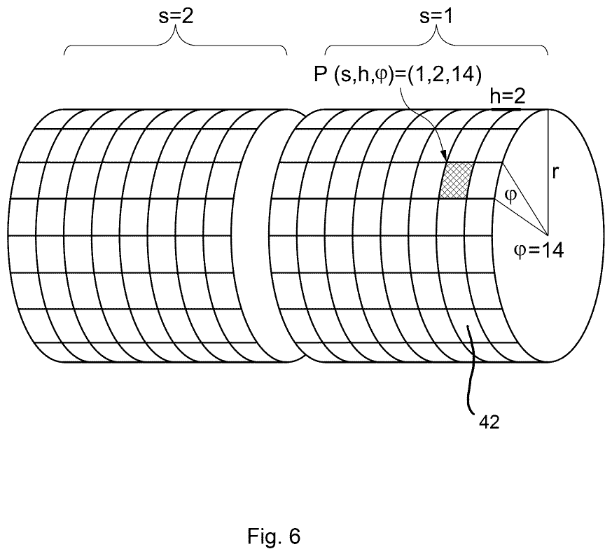

FIG. 6 shows a further illustration of a digital map in a computer unit of an implement according to an example embodiment of the invention.

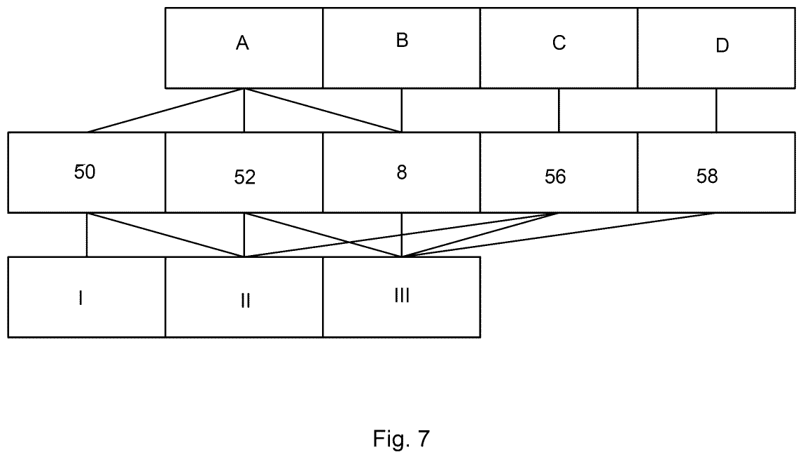

FIG. 7 shows procedures that can be performed by an implement as a function of the operating state.

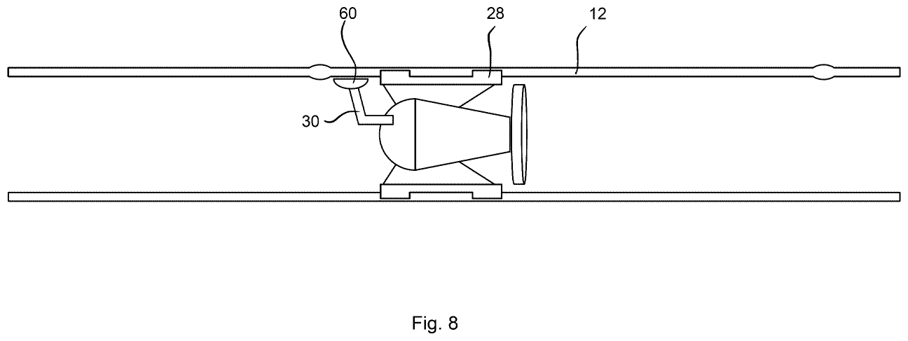

FIG. 8 shows a subject according to an example embodiment of the invention.

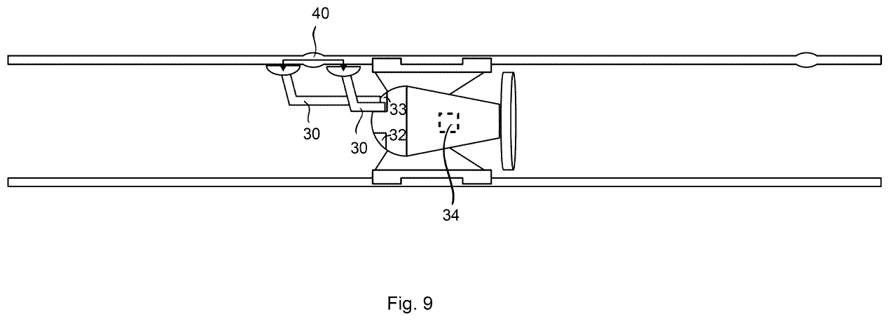

FIG. 9 shows a further subject according to an example embodiment of the invention.

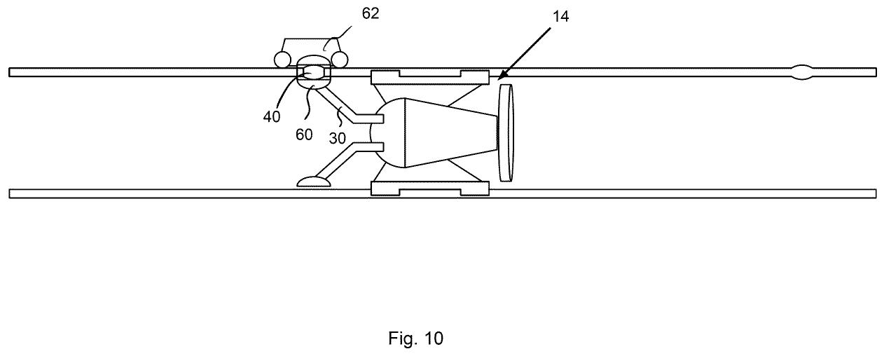

FIG. 10 shows a further subject according to an example embodiment of the invention.

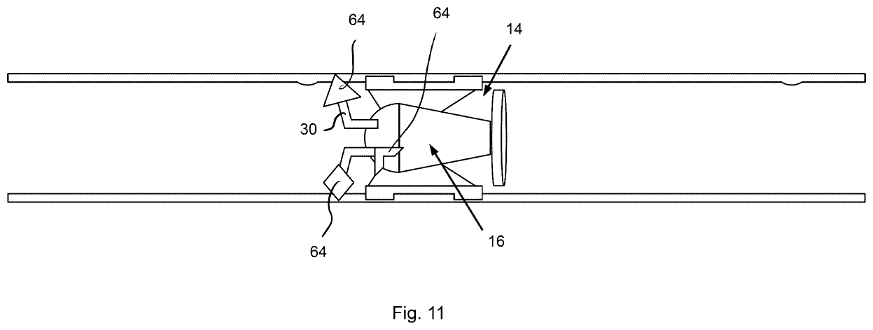

FIG. 11 shows a further subject according to an example embodiment of the invention.

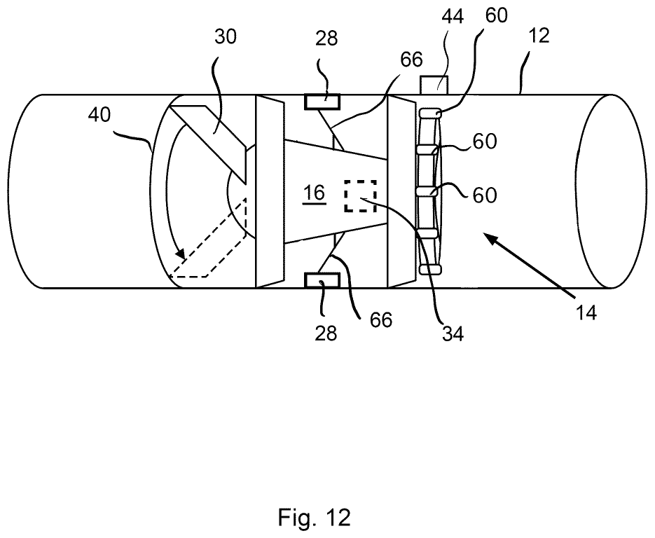

FIG. 12 shows a further subject according to an example embodiment of the invention.

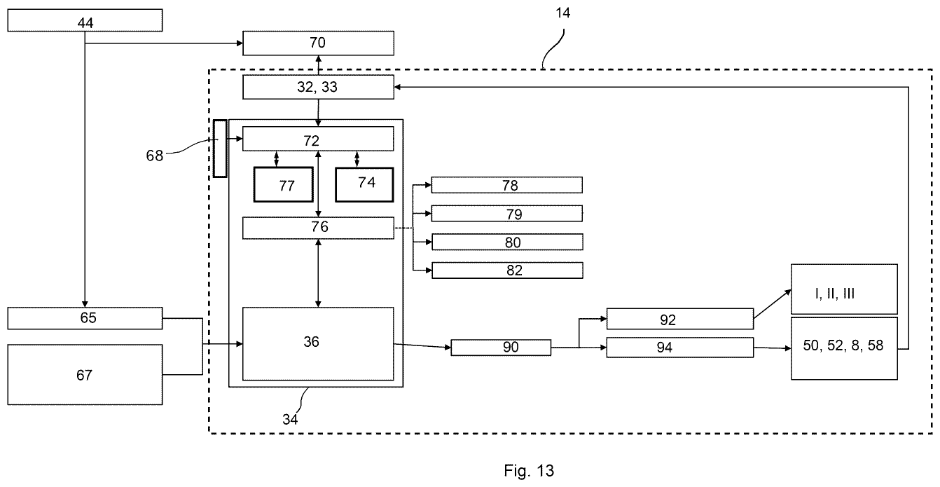

FIG. 13 shows a flowchart of an example embodiment of the invention.

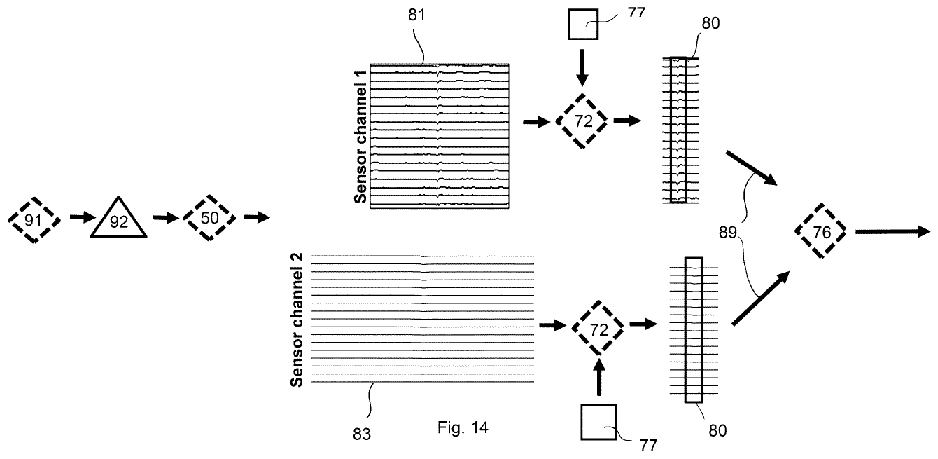

FIG. 14 shows part of an exemplary embodiment of a method according to an example embodiment of the invention.

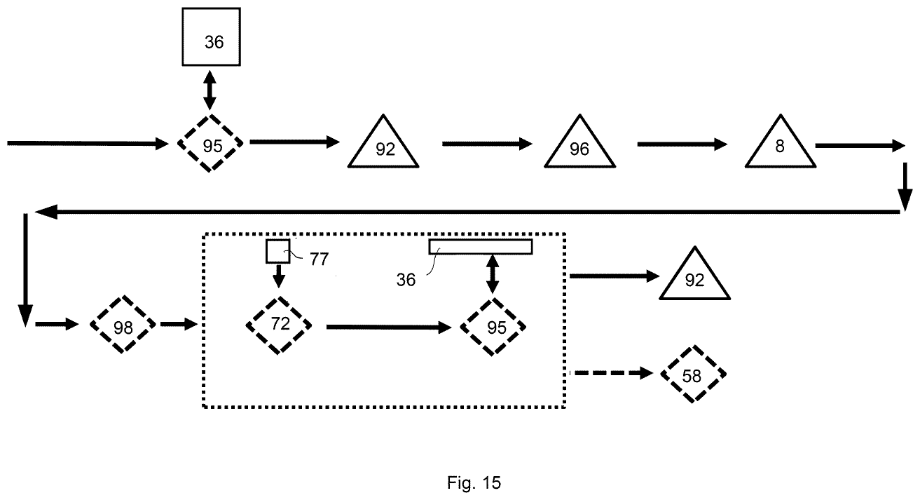

FIG. 15 shows a further part of an exemplary embodiment of a method according to an example embodiment of the invention.

Individual technical features of the exemplary embodiments described below can also be combined, in combination with above-described exemplary embodiments and the features of one of the independent claims and any further claims, to form subjects according to the invention. Where appropriate, elements that are functionally identically acting at least in parts are provided with identical reference numerals.

In a diagram representing the range of an implement in a pipeline or pipe on the X-axis and the possible task complexity on the Y-axis, conventional pigs are indeed able to cover a long range in the pipeline. Due to their dependence on the medium, however, they are only able to perform complex tasks to a limited extent. Accordingly, conventional pigs occupy the area numbered 1 in FIG. 1. Actively driven implements, such as crawlers, can, on the other hand, perform much more complex tasks, since they can actively move towards specific points and can also move against the medium in the pipeline. However, they have only a short range due to the limitation of the energy supply. From a certain length, wired implements can no longer function, since cable friction in the pipe becomes too great, especially through bends. The corresponding operating field is marked with 2 in FIG. 1. An implement according to the invention, on the other hand, can perform both the tasks that can be carried out by a conventional pig and the tasks that can be carried out by an actively moved implement, for example a crawler, and can therefore cover overall the area provided with hatched lines comprising the rectangles 1, 2 and 3. Accordingly, the implement is in the form of an advanced pig with a crawler property and can also be referred to as a pig crawler. The field of application and the capabilities of an implement according to the invention thus cover a much larger range than known from the prior art. This is made possible by an implement according to the invention which picks up, in particular classifies, its environment in a pipeline and, on the basis of this and on the basis of the data stored in a digital map, determines a position and makes any rule-based decisions autonomously.

A first flowchart according to FIG. 2 additionally illustrates different operating states I, II and III and the associated transitions. Different speeds v are assigned to the three operating states I, II and III. In operating state I, the speed v corresponds at least approximately, in particular exactly, to the speed of the medium v(medium). In operating state II, the speed of the actively moving implement is between 0 m/s and the speed of the medium v(medium), in particular between 0 m/s and half the speed of the medium. In operating state III, the speed is v=0.

A thickening bar 4 illustrates the increasing energy requirement of the implement according to the invention from operating state I via operating state II to operating state III.

Starting from operating state I of the implement, a braking process can be initiated (arrow 5), for example as a result of the environmental information-based identification and reaching of a certain waymark such as a certain circumferential or transverse weld. Such a braking process can be used to ensure that the implement approaches an outlet 6 from the line or pipeline 12 at the required speed for removal, or transitions to operating state II, in which it approaches another target defined in a digital map. When the target is reached, a further transition to operating state III can then be made, for which the implement stops (arrow 7). In this operating state, maintenance or an inspection 8 can then be carried out.

Starting from the standstill in operating state III, an active drive takes place in operating state II after releasing (arrow 9) any locking means. From operating state II, a transition to operating state I with passive drive by the medium can also take place by inactivating the active drive means and, for example, closing an existing bypass (arrow section 10).

The various operating modes and possible procedures are additionally described in FIG. 13. FIG. 3 illustrates the different states of an implement 14 according to the invention in a pipeline 12, for example in succession. A total of four different states of the implement are illustrated. For the sake of clarity, the respective illustrations of the implement do not always show all the features, but it is the same implement in each case.

An implement 14 according to the invention is in the form of a passively driven pig in operating state I. This has a central pig body 16 which has an approximately drop-shaped form with a round head part 18 which transitions into a rearwardly tapering main part 20. The implement designed as a pig in operating state I is supported in the pipeline by means of propulsion means 22 in the form of guide discs. These can also be cups. On the end, the pig is provided with an energy generation unit comprising a propeller 24 that can be electrically driven by the medium. This propeller drives a generator inside the main part 20.

Through the propulsion means 22, the medium can flow past the outside of the central or pig body 16 in a position in which the pig is fixed in the line according to operating state III. In such a case, the propeller 24 can be used together with the generator to generate energy. A closable bypass with a plurality of passages 25 is formed through the propulsion means 22 and/or the pig body 16.

In operating state II, in which the bypass is open, the implement according to the invention is supported on an inner wall of the pipeline 12 via drive means 26 in the form of caterpillar tracks. The chains of the caterpillar tracks are preferably driven via electric motors. If the implement 14 has reached its target in the pipeline 12, additional fixing means 28 can be used, via which the implement 14 is secured in the pipeline. For example, these are clamping shoes that clamp the central body firmly in the pipeline 12.

In operating state III, implement-specific actions can then be performed by means of two manipulator arms 30 in the present case; for example, certain areas of the pipeline 12 can be inspected or treated by means of a mechanical tool. According to a development of the invention, a manipulator arm 30 can also be active already in the second operating state II, for example in order to use a manipulator arm 30 in the form of a gripper arm to move a part which lies in the pipeline 12 and in particular can also be carried by the gripper arm in the first operating state I.

The transitions between the individual operating states are made on the basis of the continuous evaluation of environmental information picked up by an environmental sensor 32. For example, it is an optical sensor in the form of a camera whose camera image is examined for known patterns in a data analysis. In addition, strain gauges can be arranged in the propulsion means and can pick up bending of the propulsion means and thus information relating to the inner diameter of the pipeline. The environmental information is evaluated in a computer unit 34 of the implement. On the basis of this environmental information and the information stored in a digital map on the computer unit 34, the implement 14 independently determines its position. In particular, the implement 14 changes its operating state on the basis of this environmental information.

A digital map 36 of the pipeline is stored in the computer unit 34 (FIG. 4). Individual pipeline segments 38, which are arranged together via welds 40, are represented in this digital map. Individual pipeline segments 38 contain target fields 42, some of which can also be across pipeline segments. In addition, the digital map 36 contains information about installations 44 as well as any markers 46 in the form of magnetic markers which are fastened to the outside of the pipeline and the signal from which can be picked up within the pipeline 12. In addition, the computer unit 34 stores instructions on how to proceed in each case when the target fields 42 are reached, i.e. what type of implement-specific action is to be carried out.

In addition to relevant points, reference points such as welds 40, markers 46 and installations 40 (e.g. branches or bends) are thus also stored for orientation in the digital map 36. These reference points may be known from previous runs, a pipe journal or simply from the independent addition of certain reference points by the computer unit 34 during a run of the implement 14 in certain sections of the digital map. The digital map 36 can also represent defects or areas with defects.

When travelling through a pipeline 12, the implement 14 can now determine the number of pipeline segments 38 and thus also its position based on environmental information that makes it possible to identify welds 40. These can be additionally compared with the data from an odometer, for example, by way of a data fusion. This is advantageously done regularly during a run. For example, a weld is identified by the simultaneous occurrence of a corresponding signal from all magnetic field sensors arranged in the circumferential direction around the longitudinal axis of the implement 14 extending in the longitudinal direction of the pipeline. If the implement 14 identifies special features such as dents, these can be added in the digital map. Depending on the special feature identified or depending on the recognized feature of the pipeline 12, this feature can be examined again specifically in operating state III.

When approaching a target field 42, the implement 14 automatically changes to operating mode II and then to operating mode III when a target field 42 to be examined at a standstill has been reached.

A further example of a digital map stored in the implement 14 is represented in the exemplary embodiment according to FIG. 5. In this case, the pipeline 12 is not only defined in the X direction, but also in the circumferential direction of the pipeline 12. Different reference points or defects 48 in different circumferential positions of the pipeline 12, the inner surface of which is opened up as a 2D grid, are thus located and can also be precisely identified accordingly in the circumferential direction by means of the alignment of the implement 14 identified on the basis of an inertial measurement unit, for example, and can be specifically examined by the implement 14.

In the exemplary embodiment according to FIG. 6, the digital map 36 is stored in the computer unit 34 in the form of a representation of the pipeline 12 that is now shown in cylinder coordinates. The possible target fields 42 are defined in the individual pipeline segments S=1 and S=2 via the segment number s, which represents the number of pipeline segments, the height in the segment and the angle φ, with the result that the target field 42 marked in FIG. 6 is defined by the position 1, 2, 14.

In the individual operating states I, II and III, the individual tools in the form of environmental sensors, cleaning and repair tools according to an exemplary embodiment can be used to a different extent for the implement-specific measures (FIG. 7). For example, tools A and B are a first sensor that can be used in operating state I for long-range or coarse-resolution inspections 50, in an operating state II for screening 52, and in an operating state III for a detailed, fine-resolution inspection 8. A further sensor B, on the other hand, is only used during operating state III for detailed inspections 8. A tool C in the form of a rotating brush can be used, for example, to clean 56 the inner pipeline surface during operating states II and III, whereas a tool D in the form of a gripper arm or manipulator arm 30 is used for repair purposes only during operating state III, for example in order to move a butterfly valve of a pipeline branch.

An implement according to the invention according to FIG. 8 identifies a weld 40 of the pipeline 12 on the basis of the data from two different environmental sensors 32 and 33. If this weld is stored in the digital map as a weld to be inspected, this weld 40 is specifically examined in operating state III, in which the implement 14 in the pipeline 12 is fixed by means of the fixing means 28, using an environmental sensor 60 which is arranged on the manipulator arm or gripper arm 30. For this purpose, the environmental sensor 60 is specifically introduced into the dead zones which are formed by the weld 40 and cannot be inspected in a conventional pig run due to the sensor being lifted from the wall.

In a further exemplary embodiment of an implement 14 according to the invention, the environmental sensor is not in the form of a transmitter and receiver as in the exemplary embodiment according to FIG. 8, but rather there are two manipulator arms 30, on the ends of which a transmitter is arranged on the one hand and a receiver is arranged on the other hand, wherein these manipulator arms are specifically positioned on different sides in the dead zones of the weld 40 to be examined (FIG. 9). These are then examined, for example, using ultrasound in the pitch and catch method. As inspection tools, the tools in this case pick up signals locally generated by the implement 14 for the purpose of identifying the environment. Any defects identified from this environmental information are stored as features of the pipeline in the digital map stored in the computer unit 34.

According to a further exemplary embodiment of the invention, an X-ray emitter 62 on the outside of a pipeline can be used to generate X-rays for the examination of a weld 40 (FIG. 10). Accordingly, the environmental sensor 60 is then in the form of an X-ray receiver.

According to the exemplary embodiment in FIG. 11, an implement 14 according to the invention is provided with a plurality of tools 64 which can be fastened to the manipulator arm 30 via a corresponding interface at the end of the manipulator arm 30 and are otherwise fastened to the central body 16 and can be interchanged.

The exemplary embodiment according to FIG. 12 also again shows an implement 14 according to the invention which is fixed in the pipeline via fixing means 28. The fixing means 28 are supported on the central body 16 via extendable handlebars 66. The implement 14 is therefore in operating state III.

This operating state III was achieved, for example, by virtue of the fact that the implement regularly compared its position with a digital map 34 stored therein during the run. For this purpose, for example, the pipe segments 38 can be counted during the run in operating state I. After finding the correct pipe segment 38, the implement then moves on in operating state II to a certain position, for example marked by a marker 44, the characteristic magnetic field profile of which is detected by environmental sensors 60 and is identified with the aid of the pattern recognition performed by the computer unit 34. Subsequently, the manipulator arm 30 travels once along a weld 40 running in the circumferential direction with sensors that are not illustrated in any more detail, wherein this weld is inspected by means of ultrasound, for example. The implement 14 can then move on to a further target field 42 or can be moved on by the medium.

An embodiment of a method according to the invention is illustrated in a flowchart according to FIG. 13. First, before the start of a run, the computer unit 34 of the implement 14 is provided with a digital map 36 of the pipeline 12. This digital map 36 stores line data 65 that describe the pipeline. Said data include, for example, the number of welds, the pipeline segments and their shape (straight, bent). In addition, orders 67 are stored in the digital map and are defined, for example, by target fields, i.e. targets to be headed for, actions to be performed there and tools required for this purpose. Furthermore, rules regarding how the implement 14 has to behave in the case of certain results of the analysis can be stored in the digital map 36 or in another database 77 in the computer unit 34. For example, these may be instructions to save newly recognized features or to start a safe return to the removal location.

A marker 44 externally applied to the pipeline 12 can also be represented in the line data and thus also represents an environment feature 70 which can be perceived via the external sensors or environmental sensors 32, 33 of the implement 14. In addition, data obtained from an environmental sensor 60 can be used depending on the exemplary embodiment. The environment features are analysed in the form of environmental information from the sensors 32, 33 in the computer unit 34 in step 72. The analysis 72 can also incorporate information from internal sensors 68 which, for example, monitor the energy balance of the implement 14. The analysis 72 also incorporates information from a database 77. For the analysis 72 of the available data, it is possible to resort to one or more computer program modules 74 which are designed for rule-based recognition, for model-based recognition or for recognition on the basis of machine learning. This results in an insight or perception 76, according to which the implement 14, for example, knows its safety state 78 (e.g. sufficient energy supply) and its orientation 79 comprising position, speed and location in the pipeline. Furthermore, there is a perception 76 with respect to features 80 of the pipeline, for example comprising its size and type including defects as well as the quality and grade (collectively “82”) of the individual insights.

This perception results in an action 90 that leads, for example, to adoption 92 of an operating state I, II or III and/or the performance of an implement-specific procedure 94. The latter includes a long-range inspection 50, screening 52, for example in operating state II, a high-resolution inspection 8 in operating state III and a repair 58. The features 80 that are not yet present in the digital map 36 can also be stored therein. Alternatively or additionally, an inner coating can also be reapplied, for example.

In the exemplary embodiment according to FIG. 14, for carrying out the method according to the invention, a work order 91 is first defined and states, for example, that all unknown welds should be inspected. Based on this work order 91, the implement adopts an operating state I in the form of the pigging mode in step 92 and starts the run in the pipeline in this mode. In this pigging mode, the long-range inspection 50 is started, with which data are acquired over long distances with sensors 32, 33 and/or 60. In the present case, geometry sensors arranged in the circumferential direction around a longitudinal axis of the implement, preferably based on non-contact eddy current sensors, are used to acquire lift-off data 81 in the respective sensor channel 1. Rotation angle data 83 are acquired in the sensor channel 2. Both data sets 81 and 83 show the signal amplitude over time. In the sensor channel 1, almost all sensors show a deflection at the same time, but only a few in the sensor channel 2. The analysis step 72 is used to carry out a real-time evaluation in the computer unit 14 of the implement, in which a comparison with a database 77 takes place, for example, by means of a numerical peak finder and with the aid of a pattern recognition algorithm, based on machine learning methods, in order to identify individual features 80. In this case, a typical pattern of a circumferential weld is recognized with a certain probability, which is clearly based on the fact that a deflection is registered in the individual channels at the same time. In both data sets 81 and 83, the feature 80 is recognizable in the present case as a feature of the pipeline in the form of a circumferential weld. In a subsequent data fusion 89 of the parts of the sensor data 81 and 83 representing the feature 80, the feature 80 then results as verified in such a way that the object is assumed to be identified in the perception step 76. Based on this, it is checked in step 95 (FIG. 15) whether the feature 80 is already contained in a digital map 36 stored in the computer unit. If this is the case, the position of the implement results from the position assigned to the feature in the digital map. If this is not the case and the feature is therefore to be examined as an unknown circumferential weld, the operating state is changed again in the following step 92, now to crawler mode II, whereupon the weld is approached in step 96. For this purpose, there is a movement against the flow of the medium, in particular. Measurement data are then produced again in the subsequent high-resolution inspection 8 and are recorded and stored in the computer unit in step 98. This can also be done in parallel with the inspection 8. In the area with a dashed border in FIG. 15, there is an optional step in which a further analysis 72 in the form of a real-time evaluation takes place in the computer unit 14 of the implement in order to check the integrity of the weld. Again, comparisons with a database 77 can also be carried out here. If further features such as corrosion points of the weld are discovered, these can in turn be stored in the digital map 36 in step 95. The inspection is then completed with the transition back to a pigging mode I in which a long-range inspection is then started again. Alternatively or additionally, a possible repair of a weld can also be carried out in advance in step 58.

1. A method for operating a cable-unconnected implement in a pipeline provided with a medium flowing in the axial direction, the method comprising the steps of:
allowing the cable-unconnected implement in the pipeline to move passively by the medium in the direction of flow of the pipeline in a first operating state (I);
as the implement reaches or approaches a target in the pipeline in a second operating state (II), carrying out at least one implement-specific procedure at the target in the pipeline in at least a third operating state (III);
causing the cable-unconnected implement to move away from the target, after changing from the third to the first or second operating state,
wherein the cable-unconnected implement picks up environmental information during the first and/or second operating state using at least one environmental sensor the environmental information being evaluated in a computer unit of the implement, wherein the implement independently changes the operating state III) on the basis of the environmental information.

2. The method according to claim 1, wherein at least one feature of the pipeline is identified in the computer unit by evaluating the environmental information.

3. The method according to claim 2, wherein the feature with its position in the pipeline is stored in the computer unit.

4. The method according to claim 1, wherein a position of the implement in the pipeline is determined on the basis of the environmental information in the computer unit.

5. The method according to claim 1, wherein the third operating state (III) comprises a decelerated measurement run and/or arresting in the pipeline, and/or in that the implement in the second operating state (II) actively moves in the pipeline via at least one drive means.

6. The method according to claim 1, wherein the operating state is changed on the basis of the distance of the implement from the target.

7. The method according to claim 1, wherein environmental information obtained by different environmental sensors is used in the computer unit.

8. The method according to claim 1, wherein the position of the implement is determined in the computer unit on the basis of the environmental information and by a digital map of the pipeline that is stored in the computer unit.

9. The method according to claim 8, wherein reference points are represented in the digital map, and the environmental information is evaluated for the purpose of identifying reference points.

10. The method according to claim 1, wherein at least some of the environmental information is classified in the computer unit, and the data derived therefrom are compared with the data of predefined pattern classes.

11. The method according to claim 1, wherein location-dependent instructions are stored, and are carried out by the implement upon reaching the target or upon recognizing a feature.

12. The method according to claim 1, wherein the implement carries out screening of the pipeline in the second operating state (II).

13. The method according to claim 1, wherein one or more work procedures from a group of different work procedures are carried out on the basis of the evaluation of the environmental information.

14. The method according to claim 1, wherein reference points obtained from the environmental information are used to calibrate the location of the implement.

15. The method according to claim 1, wherein the digital map is supplemented with pipeline state information obtained from the environmental information and/or further sensor information.

16. The method according to claim 1, wherein the implement heads for a predefined target or a target defined during the first or second operating state.

17. The method according to claim 1, wherein the implement generates energy in at least one of the three operating states (I, II, III), by an energy generation apparatus.

18. A cable-unconnected implement comprising:
at least one propulsion means for a first operating state (I) in the form of a medium-driven, passive movement in the pipeline;
at least one environmental sensor for picking up environmental information;
at least one drive means for a second operating state (II) in the form of an active movement of the cable-unconnected implement in the pipeline; and
a computer unit, in which environmental information can be stored, said computer unit being configured such that the cable-unconnected implement carries out the method according to claim 1.

19. The implement according to claim 18, wherein the implement has positioning and/or fixing means for positioning the implement in a third operating state.

20. The implement according to claim 18, wherein the implement has at least one tool which can be activated during at least one operating state.

21. The implement according to claim 18, wherein the tool is a sensor, a cleaning tool, a coating tool or a tool removing material from a pipeline wall.

22. The implement according to claim 18, wherein the implement has at least one manipulator arm.

23. The implement according to claim 18, wherein the implement has a magazine for storing tools.

24. The implement according to claim 18, wherein environmental information-dependent instructions for changing the operating state and for actuating at least one tool are stored in the computer unit.

25. The method according to claim 2, wherein the at least one feature is used in the computer unit to determine the position of the implement.

26. The method according to claim 4, wherein the position of the implement in the pipeline is determined at least during the first and the second operating state.

27. The method according to claim 4, wherein the position of the implement in the pipeline is determined continuously.

28. The method according to claim 4, wherein the implement preferably changes the operating state (I, II, III) on the basis of the position.

29. The method according to claim 7, wherein the environmental information obtained by different environmental sensors is used in the computer unit to determine the position.

30. The method according to claim 11, wherein the location-dependent instructions are stored in the digital map and/or in at least one further data set of the computer unit.
